(19) United States
(12) Patent Application Publication
(10) Pub. No.: US 2005/0243800 A1
(43) Pub. Date: Nov. 3, 2005

(54) System and method of maintaining correct port forwarding in a residential gateway device

(76) Inventors: David Horoschak, Buckingham, PA (US); Louis D. Bifano, Morrisville, PA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 10/836,724

(22) Filed: Apr. 30, 2004

(51) Int. Cl. H04L 12/66; H04L 12/28

(52) U.S. Cl. 370/352; 370/395.3; 370/401

(57) ABSTRACT

A correct port forwarding table in a gateway device, after reset of the gateway device resulting in expiration of at least one leased private IP address of LAN devices connected thereto, is disclosed. The present invention provides a port forwarding table which binds a port to be forwarded with the unique Media Access Control (“MAC”) address of the LAN device which such port forwarding corresponds. In this way, if after a gateway device resets resulting in expiration of at least one leased private IP address of LAN devices connected thereto and if the LAN devices are leased new private addresses than prior to the expiration, the LAN devices will still receive correct port forwarding from the inventive port forwarding table of the present invention.

### FIELD OF THE INVENTION

The present invention relates to digital data networks. More specifically, the present invention relates to data routing and forwarding in a digital data network.

### BACKGROUND OF THE INVENTION

Broadband services amongst small businesses and home consumers are increasing at a rapid pace. Consistent with this trend is the proliferation of broadband devices which increase end users' capabilities and functionalities, e.g., voice over Internet Protocol (“VOIP”) devices. Thus, it is common for an end user to have multiple network devices coupled to a single broadband connection (gateway) having only one wide area network (“WAN”) Internet Protocol (“IP”) address. In order to facilitate easy addition of such devices, many broadband devices contain a Dynamic Host Configuration Protocol (“DHCP”) server to lease out IP addresses, as well as a Network Address Translation Device or “NAT” device, which provides a means for private/local addressing. A broadband device containing a DHCP server, and a NAT device is referred to herein as a “gateway device”. As such the most typical gateway device is a router. However, in addition to a DHCP server, NAT functionality, and a router, a gateway device may contain other application specific functionality, e.g., VOIP functionality.

A gateway device is conventionally connected to a WAN via a broadband interface, such as a cable modem, for example. The gateway device sits as an intermediary between the broadband interface and a plurality of broadband devices. (Please note that alternatively the broadband interface and gateway device may be integrated into one device.) In operation, the gateway device has both a WAN side and a local area network (“LAN”) side. On the WAN side, the gateway device communicates with the WAN, via the interface, typically using the single WAN IP address, made known to the gateway device from the broadband interface. On the LAN side, the gateway device is interconnected with the plurality of network devices which the end user wishes to utilize on the network. Such devices may include personal computer(s) (“PC”), file server(s), web server(s), printer(s), gaming device(s)/controller(s), etc. (hereinafter referred to as “LAN devices” for simplicity of explanation).

Upon request from a LAN device, the gateway device's DHCP server provides a private (or LAN) IP address to each LAN device to the requester. Such private address may be leased from the gateway device in a wide range of schemes: random, sequential order based upon the sequential order of requester, etc. Thus, for example, if an end user has two LAN devices, namely a web server and a client PC, the web server may receive a first private address of 192.168.1.2 (for example). The client PC may receive a second address of 192.168.1.3 (for example). In this case, since the web server sits on the LAN side of the gateway device, such web server will be invisible to the WAN unless the end user configures the gateway device to port forward, typically port 80, to private address 192.168.1.2. Such port forwarding will expose the web server to the WAN, as if the gateway device were not present.

The above described port forwarding is conventionally manifested in a port forwarding table in the gateway device. Such port forwarding table, ties, binds, or otherwise fixes a private IP address with the port forwarding request(s). The port forwarding table is often physically placed on flash EEPROM, or other type of non-volatile memory in the gateway device. Thus, if the gateway device is reset, due to a power outage, interruption, or firmware update, for example, the end user does not have to enter their previously entered port forwarding requests. However, if after the reset, the LAN devices private address leases expire, the DHCP server will lease out a new private address to any device whose lease has expired. For purposes of illustrative example, assume that the private address leases for the web server and client PC, respectively, of the present example expire. The DHCP server will then have to re-issue leases for private addresses for these devices. Since DHCP lease allocation can follow a wide variety of schemes, the web server and client PC may receive different private addresses after the reset. For example, after a reset, differentiating from the example above, the client PC may be given an address of 192.168.1.2 or maybe even a private IP address from a different LAN space, 192.168.20.1 (for example). Further, the web server may be given a private IP address of 192.168.1.3. Therefore, after the reset, the web server will be invisible to the WAN since the desired port forwarding is not in alignment with the new private IP address settings. Further, using the above example, if the client PC receives private IP address 192.168.1.2, based upon the above example, it will be open to the WAN. This is most likely an undesirable result as well. Alternative to port 80 forwarding, there are numerous other port forwarding configurations, e.g., file transfer protocol (“FTP”) typically on port 21, which will suffer the same fate.

What is needed is a system and method to maintain a correct port forwarding table in a gateway device, after a reset of the gateway device. for LAN devices connected thereto.

### SUMMARY OF INVENTION

An object of the present invention is to provide for a correct port forwarding table in a gateway device, after reset of the gateway device, for LAN devices connected thereto.

In order to achieve this objective, as well as others which will become apparent in the disclosure below, the present invention provides an inventive port forwarding table coupled to an update engine.

In an exemplary embodiment of the present invention, the inventive port forwarding table has at least three (3) fields: a port to be forwarded field (“port field”), LAN device MAC address field (“MAC field”), and a LAN device private IP address field (as given by the DHCP server, “private address field”). The port field and MAC field are bound to each other and fixed in non-volatile memory of the gateway device. Thus, a port forwarding request is bound to a corresponding MAC address (an actual specific LAN device). The private address field is dynamic.

In operation, after a gateway device containing, or otherwise coupled to, the system and method of the present invention resets, where at least one leased private address expires, and LAN devices interconnected to the gateway device receive different private addresses (than prior to the reset), the inventive port forwarding table of the present invention will still provide the correct port forwarding because (i) the inventive table binds the MAC field to the port field, and (ii) the update engine will update the private address field in the inventive port forwarding table by keying in on the MAC address of each LAN device. Hence, since the port field is bound to the MAC field, port forwarding configuration(s) will be functionally the same as before the reset. This places the new (post-reset) private address allocation in line with the previous port forwarding configuration(s).

Thus, the system and method of the present invention maintains a correct port forwarding table in a gateway device, after reset of the gateway device, for LAN devices connected thereto.

### BRIEF DESCRIPTION OF THE DRAWINGS

For a complete understanding of the present invention and the advantages thereof, reference is now made to the following description taken in conjunction with the accompanying drawings in which like reference numbers indicate like features, components and method steps, and wherein:

FIG. 1(a) is an illustration of a prior art port forwarding table for a gateway device;

FIG. 1(b) is an illustration of a prior art LAN system prior to reset of a gateway device incorporated therein;

FIG. 1(c) is an illustration of a prior art LAN system after reset of a gateway device incorporated therein;

FIG. 1(d) is an illustration of a prior art LAN system after reset of a gateway device incorporated therein wherein the private IP address range/space has changed;

FIG. 2(a) is an illustration of an inventive port forwarding system in accordance with an exemplary embodiment of the present invention;

FIG. 2(b) is an illustration of the inventive port forwarding table of FIG. 2(b) prior to the reset of a gateway device in accordance with an exemplary embodiment of the present invention;

FIG. 2(c) is an illustration of a system for maintaining a correct port forwarding table after the reset of a gateway device, prior to said reset in accordance with the inventive port forwarding system of FIG. 2(a);

FIG. 2(d) is a flow diagram showing the basic process flow for maintaining a correct port forwarding table after the reset of a gateway device in accordance with an exemplary embodiment of the present invention;

FIG. 2(e) is an illustration a system for maintaining a correct port forwarding table after the reset of a gateway device in accordance with the inventive port forwarding system of FIG. 2(a); and

FIG. 2(f) is an illustration of an inventive port forwarding table after the reset of a gateway device in accordance with an exemplary embodiment of the present invention.

### DESCRIPTION OF A PRESENTLY PREFERRED EMBODIMENT

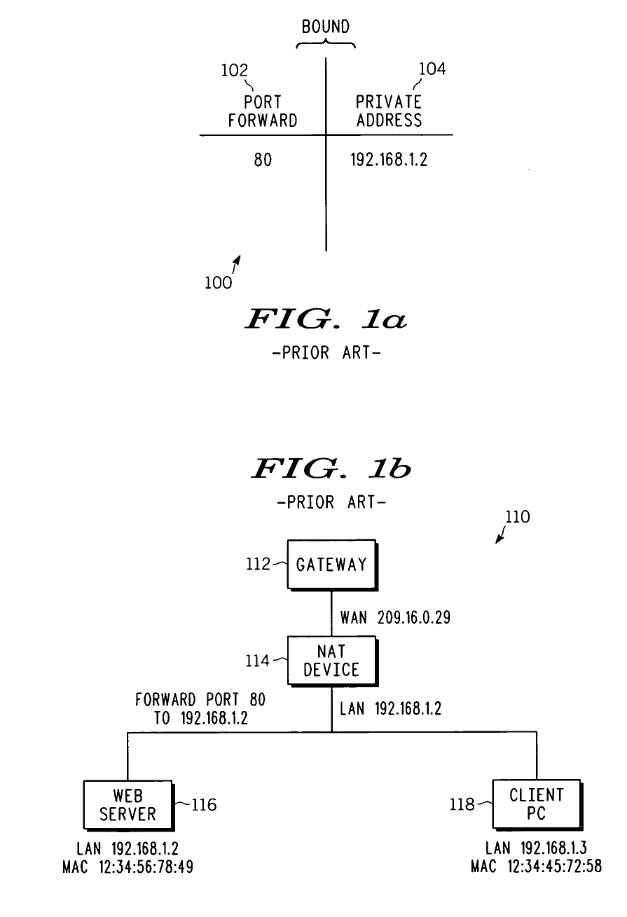

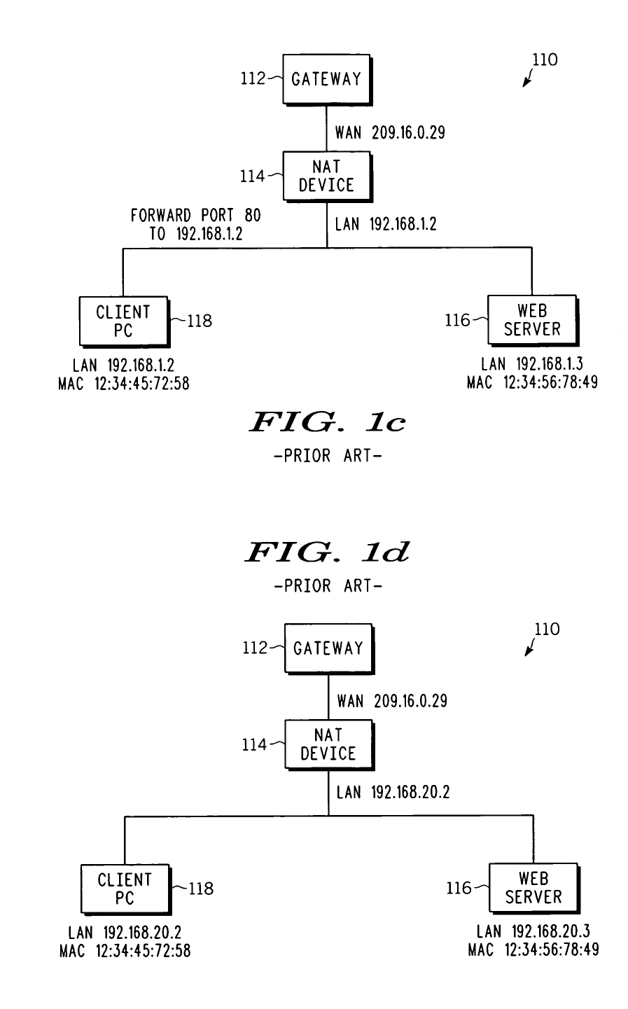

It is essential to comprehend conventional gateway device port forwarding in order to understand the substance of the present invention. Referring to FIG. 1(a), a prior art port forwarding table 100 is shown. FIG. 1(a) is a port forwarding table found in many commonly known gateway devices. FIG. 1(a) contains a port forwarding field 102 and a private address field 104. The data values for the conventional port forwarding table 100 are typically retained in non-volatile memory. Further, the port forwarding field data values are bound to corresponding private address data values. For example, using FIG. 1(a) as an example, the forwarding of port “80” is bound/tied to the LAN device at private address 192.168.1.2. Such configuration values are most typically set manually by an end user.

Referring to FIG. 1(b), FIG. 1(b) illustrates a common prior art system 110. Prior art system 110 includes a broadband interface (“interface”) 112, a gateway device 114, and two LAN devices, namely, a web server 116 and a client PC 118.

A gateway device 114 is conventionally connected to a WAN via the interface 112. The interface 112 may be a broadband cable modem for example. The gateway device 114 sits as an intermediary between the interface 112 and a plurality of broadband, in this instance web server 116 and client PC 118. In operation, the gateway device 114 has both a WAN side and a LAN side, as described above. On the WAN side, the gateway device 114 communicates with the WAN, via the interface 112, typically using the single WAN IP address, 209.16.0.29 (for example), which the gateway device 114, made known to the gateway device 114 from the interface 112. On the LAN side, the gateway device 114 is interconnected with the plurality of LAN devices (116, 118) which the end user wishes to utilize on the network.

Upon request from a LAN device 116, 118, the gateway device 114 leases a private address to each LAN device. Such private address may be leased from the gateway device 114 in a wide range of schemes: random, sequential order based upon the sequential order of requester, etc. The importance here being that the leasing scheme is not standardized. Thus, for example, using FIG. 1(b), if the web server 116 requests a private address it may be given a first private address, 192.168.1.2. Upon request, the client PC 118 may be given a second private address of 192.168.1.3. Here, the gateway device 114 assigns itself a private address of 192.168.1.1, the first address in the address space.

Since the web server 116 sits on the LAN side of the gateway device, such web server will be invisible to the WAN unless the end user configures the gateway to port forward, typically port 80, to private address 192.168.1.2. Assuming the end user completes such port forwarding configuration in the gateway device 114, the conventional port forwarding table (see FIG. 1(a)) of conventional gateway device 114 will reflect such configuration and effectuate such port forwarding in operation. If no intervening lease expiration has occurred due to a reset, or other anomaly, of the gateway device 114, this port forwarding will expose web server 116 to the WAN, as if the gateway device 114 were not present.

Thus, the conventional port forwarding table bind/ties a private address with the port forwarding request. This port forwarding table is often physically placed on flash EEPROM, or other type of non-volatile memory in the gateway device 114.

If conventional gateway device 114 is reset, due to a power outage, interruption or firmware update, the gateway device 114 will retain the above described conventional port forwarding table.

Referring to FIG. 1(c), on a reset of the gateway device 114 (or other event), some or all of the leased private addresses may expire. Please note that a LAN device that leaves the LAN for an extended period of time (past a pre-defined threshold) may also find its leased private address expired. For illustrative purposes, assume that a reset has occurred and that all leased private addresses have expired, and the DHCP server in gateway device 114 again allocates private address. Since, the DHCP server may lease addresses based upon a variety of schemes, the LAN devices 116, 118 may not receive the same address as prior to the lease expiration, in which case the port forwarding configuration will be misaligned and will be ineffective. For example, if after the reset, differentiating from the example above, the client PC 118 is given a private address of 192.168.1.2 and the web server 118 receives a private address of 192.168.1.3. Thus, after the reset, the web server 116 will be invisible to the WAN since the desired port forwarding is not in align with the new private address settings. Further, if the client PC 118 receives private address 192.168.1.2, based upon the above example, it will be open to the WAN. This is most likely an undesirable result as well. Alternatively, if the DHCP server leases private addresses in a different address space, 192.168.20.X, no LAN devices 116, 118 will be visible to the WAN as shown in FIG. 1(d). (Port 80 is used herein solely as an illustrative example, as numerous other port forwarding configurations are possible, e.g., file transfer protocol (“FTP”) typically on port 21.)

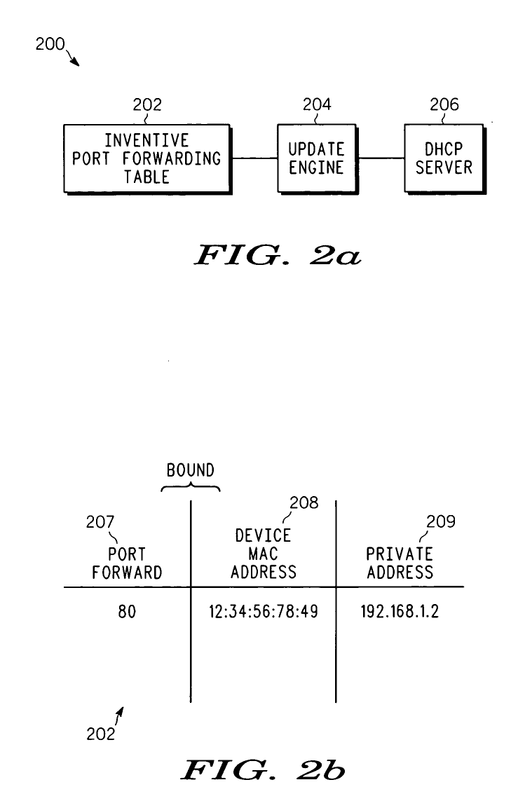

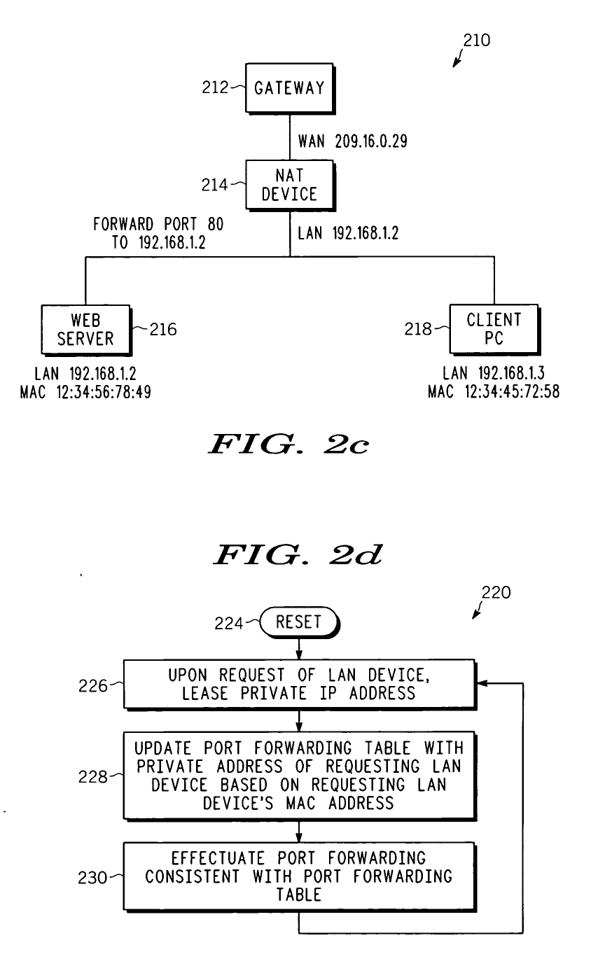

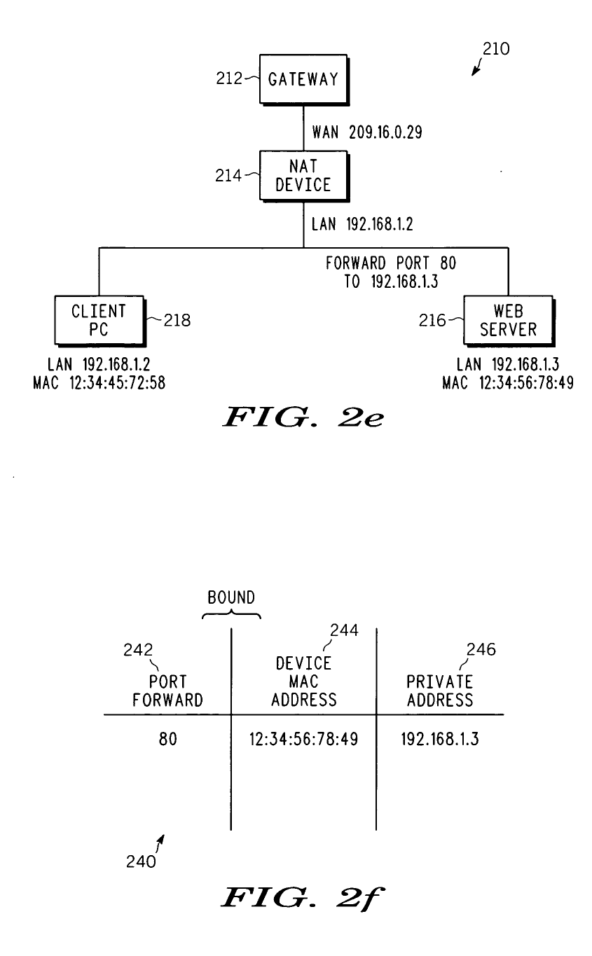

Referring to FIG. 2(a), in accordance with an exemplary embodiment of the present invention the above problem is alleviated by providing an inventive port forwarding system 200. Inventive port forwarding system 200 includes an inventive port forwarding table 202 coupled to a update engine 204 to be utilized or otherwise integrated into a gateway device. The update engine is communicatively coupled to the DHCP server 206 of the gateway device to receive leased private address data from the DHCP server 206.

Referring to FIG. 2(b), the inventive port forwarding table 202 has at least three (3) fields: a port field 207, MAC field 208, and a private address field 209. The port field 207 and MAC field 208 are bound to each other and fixed in non-volatile memory, preferably memory inside the gateway device. Thus, a port forwarding request is bound to a corresponding MAC address (an actual specific LAN device). The private address field is dynamic.

The exemplary port forwarding of FIG. 2(b) is illustrated in FIG. 2(c). Here, the port 80 is forwarded to web server 216, having a MAC address of 12:34:56:78:49, and having a current private address of 192.168.1.2.

Referring to FIGS. 2(d), 2(e), and 2(f) simultaneously, in operation, after a gateway device 214 containing the system and method of the present invention resets and one or all leased private addresses expire, in step 224, LAN devices 216, 218 interconnected to the gateway device 214 may receive/lease different private addresses (than prior to the reset) from the DHCP server 206, in step 226 (also is FIG. 2(e)). Next, the update engine 204 receiving this new private address data from the DHCP server 206, updates the private address field 246 in the inventive port forwarding table 240 by keying on the MAC address field 244. Here, for example, since the web server 216, having a MAC address of 12:34:56:78:49, now has a new private address of 192.168.1.3, the update engine 204 will update the record in the port forwarding table 240 containing the MAC address 12:34:56:78:49 with a private address of 192.168.1.3, in step 228. Now when the port forwarding table is effectuated, in step 230, port 80 will still be forwarded to web server 216, as prior to the reset, as shown in FIG. 2(e). The above inventive port table updating may be performed using a variety of updating schemes or engines, including, but not limited to, the use of the address resolution protocol (“ARP”) and ARP tables.

Further, even though the system and method of the present invention binds the port field 242 and MAC address field 244, in actual end user configuration, the system and method can still allow the end user to configure port forwarding using then current private addresses. The system and method of the present invention would then simply complete the MAC address field data value in the inventive port forwarding table 240 for the end user. This keeps the end user's configuration practice familiar for the end user.

Thus, the system and method of the present invention maintains a correct port forwarding table in a gateway device, after reset of the gateway device, for LAN devices connected thereto.

Although the invention has been described herein by reference to an exemplary embodiment thereof, it will be understood that such embodiment is susceptible of modification and variation without departing from the inventive concepts disclosed. All such modifications and variations, therefore, are intended to be encompassed within the spirit and scope of the appended claims.

1. A system for maintaining a correct port forwarding table in a network translation after reset of said network translation device resulting in expiration of at least one leased private addresses of network devices connected thereto, said system comprising:
a port forwarding table, said port forwarding table comprising at least a port forwarding field, a network device Media Access Control field, and a network device leased private Internet protocol address field; and
a update engine for updating said leased private address field of said port forwarding table based upon said network device Media Access Control address field.

2. The system of claim 1, wherein said port field and said Media Access Control field are maintained in non-volatile memory.

3. The system of claim 2, wherein said non-volatile memory comprises at least one of flash memory, a hard drive, optical drive, and optical-magnetic drive.

4. The system of claim 1, wherein said port field and said Media Access Control field are linked.

5. The system of claim 1, wherein said leased private address field is a dynamic field.

6. A method for maintaining a correct port forwarding table in a network translation after reset of said network translation device resulting in expiration of at least one leased private addresses of network devices connected thereto, said method:
storing a port forwarding field data;
storing a network device Media Access Control field data;
linking said port field data to said media access field data; and
storing a network device leased private Internet protocol address field data;
updating said leased private address field data upon a change in at least one leased private address based upon said Media Access Control field data.

7. The method of claim 6, wherein step of storing said port field data comprises storing said port field data in non-volatile memory.

8. The method of claim 6, wherein step of storing said Media Access Control field data comprises storing said media access field data in non-volatile memory.

9. A computer-readable carrier including computer program instructions that instruct a computer to perform the steps of:
storing a port forwarding field data;
storing a network device Media Access Control field data;
linking said port field data to said media access field data; and
storing a network device leased private Internet protocol address field data;
updating said leased private address field data upon a change in at least one leased private address based upon said Media Access Control field data.

10. The computer-readable carrier of claim 9, wherein step of storing said port field data comprises storing said port field data in non-volatile memory.

11. The computer-readable carrier of claim 9, wherein step of storing said Media Access Control field data comprises storing said Media Access Control field data in non-volatile memory.
